(19) United States
(12) Patent Application Publication
(10) Pub. No.: US 2005/0187898 A1
(43) Pub. Date: Aug. 25, 2005

(54) Data Lookup architecture

(75) Inventors: Bernard Chazelle, Princeton, NJ (US); Joseph Kilian, West Windsor, NJ (US); Ronitt Rubinfeld, Brookline, MA (US); Ayellet Tal, Technion City (IL)

Correspondence Address: NEC LABORATORIES AMERICA, INC., 4 INDEPENDENCE WAY, PRINCETON, NJ, 08540, US

(73) Assignee: NEC Laboratories America, Inc., Princeton, NJ (US)

(21) Appl. No.: 10/909,901

(22) Filed: Aug. 2, 2004

Related U.S. Application Data
(60) Provisional application No. 60/541,983, filed on Feb. 5, 2004.

(51) Int. Cl. G06F 7/00

(52) U.S. Cl. 707/1

(57) ABSTRACT

A lookup architecture is herein disclosed that can support constant time queries within modest space requirements while encoding arbitrary functions and supporting dynamic updates.

This Utility Patent Application is a Non-Provisional of and claims the benefit of U.S. Provisional Patent Application Ser. No. 60/541,983 entitled “INEXPENSIVE AND FAST CONTENT ADDRESSABLE MEMORY” filed on Feb. 5, 2004, the contents of which are incorporated by reference herein.

### BACKGROUND OF THE INVENTION

The present invention relates to information retrieval.

There are a variety of known data structures for supporting lookup queries. Hash-based lookup schemes typically provide the fastest known lookups for large databases. Given an input value, a hash function is applied to the input and perhaps other data in the data structure to yield one or more indices, and the data structure can be queried at these indices in order to search for the output value. A common feature of prior art hashing-based retrieval schemes is that at one or more locations in a lookup table, information is stored that allows one to determine the output value corresponding to the given input value. Thus, hashing-based schemes typically work by searching for the entry containing this information. Consider, for example, a recent hash-based scheme referred to in the art as “cuckoo hashing.” See Pagh, R. and Rodler, F., “Cuckoo Hashing,” Journal of Algorithms, 51, pages 122-144 (2004). In cuckoo hashing, an input value t is hashed to obtain two locations, L₁ and L₂. One then queries the data structure at both of these locations. At each location there is either an empty marker or an (input value, output value) pair. If for one of the locations, L₁ or L₂, there is an (input value, output value) pair such that the input value is equal to t, then the given output value can be retrieved. Once the location with the matching input value is identified, the output value is obtained without any need to consult or utilize the contents of the other location(s). Thus, the input value is explicitly stored at the location which stores the output value, which can result in a great deal of inefficiency, for example, where the input values are a hundred bits long and the output values are a single bit. Other standard hashing-based techniques can reduce this inefficiency, but nevertheless incur a storage overhead typically proportional to log(n) bits per stored entry, where n is the number of input elements, resulting in a storage requirement proportional to nlog(n) bits.

It would be clearly advantageous to have a lookup system with improved storage requirements. A “Bloom filter” is a known lossy encoding scheme for binary functions used to conduct membership queries for a given set of input values. See Bloom B. H., “Space/Time Trade-offs in Hash Coding with Allowable Errors,” Communications of the ACM, 13(7), pp. 422-426 (July 1970). The data structure consists of a bit-vector of length m. The Bloom filter is initially programmed by hashing each input k times to produce k indices between 0 and m. The bit-vector entries corresponding to these indices are set to 1. A query on a message M proceeds as follows. M is hashed k times and each of the k locations in the bit-vector is checked. Clearly, if the value stored at any location is 0, M is not part of the data contained in the Bloom filter. If all the entries are 1, however, M is most likely a part of the data contained in the Bloom filter. A false positive possibility arises from the fact that the hash functions can result in the same set of k values for two different inputs. By allowing false positives, the Bloom filter can fit within storage proportional to n bits. Part of the reason Bloom filters achieve their space efficiency is by combining in a nontrivial way the values obtained from the k locations queried. A location containing a 1 contains no information about which input value it is affirming as being in the set—this lack of information allows for the space efficiency. This can cause confusion, as an input value not in the given set might still hash to k locations, all set to 1 by different input values. By computing an AND of all of these value, instead of relying on a single one, one reduces the probability of such mistakes to an acceptable value.

Unfortunately, although Bloom filters allow membership queries to be conducted, they do not allow one to associate an output value to an input value belonging to some given set. Although a number of variants of Bloom filters have been proposed, there is still a need for a generalized scheme which can associate output values with input values for a given set, while obtaining the small storage requirements enjoyed by Bloom filters.

### SUMMARY OF THE INVENTION

In accordance with an embodiment of the invention, a lookup architecture is herein disclosed which receives an input value and compactly stores arbitrary lookup values associated with different input values in a pre-specified lookup set. The data lookup architecture comprises a table of encoded values. The input value is hashed a number of times to generate a plurality of hashed values and, optionally, a mask, the hashed values corresponding to locations of encoded values in the table. The encoded values obtained from an input value encode an output value such that the output value cannot be recovered from any single encoded value. For example, the encoded values can be encoded by combining the values using a bit-wise exclusive or (XOR) operation, to generate the output value. The output value can then be used to retrieve the lookup value associated with the input value, assuming the input value is in the pre-specified lookup set. If it is not, then the output value will take on a value outside a pre-specified range and it can be readily recognized that the input value does not have an associated lookup value. In accordance with an embodiment of the invention, the lookup architecture further comprises a second table which stores each lookup value at a unique index in the second table, thereby readily facilitating update of the lookup values without affecting the encoded values. The table of encoded values can be constructed so that the output value generated by the bit-wise XOR operation is an index in the second table where the associated lookup value is stored, or may be combined with input value to obtain such an index

The present invention advantageously enables a constant query time with modest space requirements while still being able to encode arbitrary functions. It can respond to a membership query and retrieve any stored value associated with the input value. If the stored values are small (a constant number of bits) then the space required by the lookup architecture requires only a constant number of bits per input value, regardless of the size of the input values or the number of input values. This is in contrast to previous lookup architectures, which must either store the input values or hashes of the input values, and whose space requirement per input value grows as the logarithm of the number of input values. These and other advantages of the invention will be apparent to those of ordinary skill in the art by reference to the following detailed description and the accompanying drawings.

### BRIEF DESCRIPTION OF DRAWINGS

FIG. 1 is a diagram of a lookup architecture, in accordance with an embodiment of the invention.

### DETAILED DESCRIPTION OF THE INVENTION

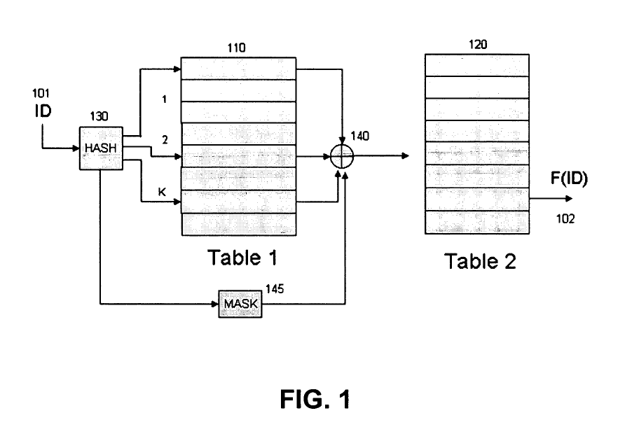

FIG. 1 is a diagram of a lookup architecture, in accordance with an embodiment of the invention. As depicted in FIG. 1, an input value 101 is received and processed by the architecture. Based on the processing of the input value 101, what is output is a lookup value 102 retrieved from a table 120 or an error code indicating that the input value is not a member of the lookup set.

In FIG. 1, there are two tables 110, 120, the construction and operation of which are described in further detail herein. Table 120 is referred to herein as a lookup table and comprises a plurality of entries, each storing a lookup value. Table 110 is referred to herein as the “encoding” table. Encoding table 110 is constructed so that there is a one-to-one mapping between every valid input value within the particular pre-specified lookup set and a unique location in lookup table 120, as described in further detail below.

To lookup the value 102 associated with an input value 101, the input value 101 is hashed at 130 to produce k different values and a mask M at 145. The hash 130 can be implemented using any advantageous hash function. The k different hash values, (h₁, . . . , hₖ), each refer to locations in the encoding table 110. Each hᵢ is in the interval [1, m] where m is the number of entries in the encoding table 110 and the lookup table 120. Each entry in the encoding table 110 stores a value, Table1[hᵢ]. The values Table1[h₁] . . . Table1[hₖ] selected by the k hash values and the mask M are bit-wise exclusive-ored at 140 to obtain the following value:
x=M⊕⊕ᵢ₌₁^{k}Table1[hᵢ]
This value is an index to a location in the lookup table 120 that can be used to retrieve the lookup value f(t) associated with the input value t. If the value falls outside the valid index range, then the input value 101 is not part of the lookup set.

Given a domain D and a range R, the lookup structure encodes an arbitrary function F:D→R such that querying with any element t of D results in a lookup value of f(t). Any t that is not within the domain D is flagged.

Construction of the encoding table 110 can proceed in a number of different ways. Given an input value t and an associated index value, l, the below equation for l defines a linear constraint on the values of the encoding table 110. The set of input values and associated indices defines a system of linear constraints, and these linear constraints may be solved using any of the many methods known in the literature for solving linear constraints.

Alternatively, and in accordance with an embodiment of the invention, the following very fast method can be utilized that works with very high probability. The encoding table 110 is constructed so that there is a one-to-one mapping between every element t in the lookup set and a unique index τ(t) in the lookup table 120. It is required that this matching value, τ(t), be one of the hashed locations, (hₗ, . . . , hₖ), generated by hashing t. Given any setting of the table entries, the linear constraint associated with t may be satisfied by setting
Table1[L]=l⊕M⊕⊕_{l≠i=1}^{k}Table1[hᵢ].
However, changing the entry in the encoding table 110 of Table1[τ(t)] may cause a violation of the linear constraint for a different input value whose constraint was previous satisfied. To avoid this, an ordering should be computed on the set of input elements. The ordering has the property that if another input value t′ precedes t in the order, then none of the hash values associated with t′ will be equal to τ(t). Given such a matching and ordering, the linear constraint for the input elements according to the order would be satisfied. Also, the constraint for each t would be satisfied solely by modifying τ(t) without violating any of the previously satisfied constraints. At the end of this process, all of the linear constraints would be satisfied.

The ordering and τ(t) can be computed as follows: Let S be the set of input elements. A location L in the encoding table is said to be a singleton location for S if it is a hashed location for exactly one t in S. S can be broken into two parts, S₁ consisting of those t in S whose hashed locations contain a singleton location for S, and S₂, consisting of those t in S whose hashed locations do not contain a singleton location for S. For each t in S₁, τ(t) is set to be one of the singleton locations. Each input value in S₁ is ordered to be after all of the input values in S₂. The ordering within S₁ may be arbitrary. Then, a matching and ordering for S₂ can be recursively found. Thus, S₂ can be broken into two sets, S₂₁ and S₂₂, where S₂₁ consists of those t in S₂ whose hashed locations contain a singleton location for S₂, and S₂₂ consists of the remaining elements of S₂. It should be noted that locations that were not singleton locations for S may be singleton locations for S₂. The process continues until every input value t in S has been given a matching value τ(t). If at any earlier stage in the process, no elements are found that hash to singleton locations, the process is deemed to have failed. It can be shown, however, that when the size of the encoding table is sufficiently large, such a matching and ordering will exist and be found by the process with high probability. In practice, the encoding table size can be set to some initial size, e.g., some constant multiple of the number of input values. If a matching is not found, one may iteratively increase the table size until a matching is found. There is a small chance that the process will still fail even with a table of sufficiently large size due to a coincidence among the hash locations. In this case, one can change the hash function used. Note that one must use the same hash function for looking up values as one uses during the construction of the encoding table.

It should be noted that the encoding table can be utilized with the above-described table construction and lookup procedures to directly store the lookup values. It is difficult, however, to change the value associated with an input value when one is solely using the encoding table. To allow for quicker updates, it is advantageous to use the encoding table as an index into a second table, the lookup table, as depicted in FIG. 1. For each value t in the set of input values, a unique location L(t) in the lookup table is associated. Some encoding of L(t) is stored in the encoding table, and stores the value v associated with t in the lookup tagble at Table2[L(t)]. Any one-to-one mapping may be used from the set of input values and locations in the lookup table, and any method of encoding these locations. In one embodiment, the lookup table can be the same size as encoding table. Then, the same matching can be used as for the creation of the encoding table, L(t)=τ(t). In this case, given t, L(t) has a very succinct encoding. Recall that t is hashed to obtain k values, and that L(t)=τ(t) is one of these hashed values. Hence, one may encode L(t) as a value from 1 to k. If k=4, L(t) may be encoded using only 2 bits.

1. A lookup architecture that stores values associated with input values in a lookup set comprising:
a hashing module that receives an input value and generates a plurality of hashed values from the input value;
a table storing a plurality of encoded values, each hashed value generated from the input value corresponding to a location in the table of an encoded value, the table constructed so that the encoded values obtained from the input value encode an output value such that the output value cannot be recovered from any single encoded value.

2. The lookup architecture of claim 1 wherein, if the output value is outside a pre-specified range, then the input value is not in the lookup set and does not have an associated lookup value.

3. The lookup architecture of claim 1 wherein the encoded values encode the output value such that the output value is recovered by combining the encoded values by performing a bit-wise XOR operation.

3′. The lookup architecture of claim 1 wherein a mask is also generated by the hashing module from the input value and the mask is also used to encode the output value associated with the input value.

4. The lookup architecture of claim 1 further comprising
a second table storing lookup values so that the output value associated with the input value is also associated with a location in the second table where the lookup value associated with the input value is stored.

5. The lookup architecture of claim 4 wherein the lookup values stored in the second table can be updated without changing the table storing the plurality of encoded values.

6. A computer-readable medium comprising instructions for performing a lookup query for values associated with input values in a lookup set, the instructions when executed on a computer perform the method of:
receiving an input value;
hashing the input value to generate a plurality of hashed values from the input value;
retrieving a plurality of encoded values stored at locations in a table corresponding to the plurality of hashed values and recovering an output value from the encoded values where the encoded values encode the output value such that the output value cannot be recovered from any single encoded value.

7. The computer-readable medium of claim 6 wherein, if the output value is outside a pre-specified range, then the input value is not in the lookup set and does not have an associated lookup value.

8. The computer-readable medium of claim 6 wherein the encoded values encode the output value such that the output value is recovered by combining the encoded values by performing a bit-wise XOR operation.

9. The computer readable medium of claim 6 wherein a mask is also generated by hashing the input value and the mask is also used to encode the output value associated with the input value.

10. The computer-readable medium of claim 6 wherein the output value recovered is associated with a location in a second table storing a lookup value associated with the input value.

11. A method for performing a lookup query for values associated with input values in a lookup set, the method comprising the steps of:
receiving an input value;
hashing the input value to generate a plurality of hashed values from the input value;
retrieving a plurality of encoded values stored at locations in a table corresponding to the plurality of hashed values and recovering an output value from the encoded values where the encoded values encode the output value such that the output value cannot be recovered from any single encoded value.

12. The method of claim 11 wherein, if the output value is outside a pre-specified range, then the input value is not in the lookup set and does not have an associated lookup value.

13. The method of claim 11 wherein the encoded values encode the output value such that the output value is recovered by combining the encoded values by performing a bit-wise XOR operation.

14. The method of claim 11 wherein a mask is also generated by hashing the input value and the mask is also used to encode the output value associated with the input value.

15. The method of claim 11 further comprising the step of:
retrieving a lookup value from a location in a second table, where the output value recovered is associated with the location in the second table storing the lookup value associated with the input value.
